(19) United States
(12) Patent Application Publication
(10) Pub. No.: US 2022/0255495 A1
(43) Pub. Date: Aug. 11, 2022

(54) Tilting Arrangement for a Photovoltaic Module Rack

(71) Applicant: Brantingham and Carroll Holdings, Inc., Leetsdale, PA (US)

(72) Inventors: Marvin Hochstedler, Melipilla (CL); Matthew P. Carroll, Leetsdale, PA (US); Soren Jensen, Corte Madera, CA (US); José Miguel Tomicic Müller, Santiago (CL); James A. Carroll, Aiken, SC (US)

(21) Appl. No.: 17/665,833

(22) Filed: Feb. 7, 2022

Related U.S. Application Data
(60) Provisional application No. 63/146,910, filed on Feb. 8, 2021.

(51) Int. Cl. H02S 20/30; F16M 11/10

(52) U.S. Cl. CPC H02S 20/30; F16M 11/10

(57) ABSTRACT

An arrangement for a photovoltaic module, the arrangement including at least one support member and a tilting rack, the tilting rack including at least one beam and at least one rafter, in which the at least one beam is operatively connected to at least one end of the at least one rafter, in which the tilting rack is operatively connected to the at least one support member at or near a center of gravity of the at least one rafter, and in which the titling rack is configured to rotate at or near the center of gravity of the at least one rafter.

### CROSS REFERENCE TO RELATED APPLICATION

This application claims benefit of priority from U.S. Provisional Patent Application No. 63/146,910, filed Feb. 8, 2021, the contents of which is incorporated herein by reference in its entirety.

### BACKGROUND OF THE INVENTION

### Field of the Invention

The present disclosure is directed to a photovoltaic module arrangement or rack and, more particularly, to a tilting arrangement for a photovoltaic module rack.

### Description of Related Art

There is a current problem in the present industry in that, as the photovoltaic module arrangements are currently being built at their final location and angle, which puts the lowest connection point at about two feet above the ground, there exists limited access during assembly to a backside of a photovoltaic module on fixed racks or arrangements. Current solutions to this problem include: 1) installers either lay on their backs on the ground, or crouch down and sit on the ground to make the lowest connections on the backside; 2) the arrangement is raised a little higher above the ground; or 3) the connection is made from the top side using a “top-down” clamp. Working either from a sitting or lying down position can be done nearly as quickly as from a more comfortable position for a short period of time. However, working from an uncomfortable position all day long results in worker fatigue and dissatisfaction. Raising the arrangement higher above the ground increases the material cost and makes the higher connections less accessible. Use of a top-down clamp results in significant cost increases especially for large utility scale projects. There is a current need in the industry for an improved arrangement and method for assembling a photovoltaic module on a fixed rack.

### SUMMARY OF THE INVENTION

In one embodiment, an arrangement for a photovoltaic module is provided. The arrangement may include at least one support member, and a tilting rack. The tilting rack may include at least one beam and at least one rafter, the at least one beam operatively connected to at least one end of the at least one rafter, wherein the tilting rack is operatively connected to the at least one support member at or near a center of gravity of the at least one rafter, and wherein the titling rack is configured to rotate at the center of gravity of the at least one rafter.

In another embodiment, a method of installing an arrangement for a photovoltaic module is provided. The method may include providing at least one support member and a tilting rack, the tilting rack comprising at least one beam and at least one rafter, the at least one beam operatively connected to at least one end of the at least one rafter, and connecting the at least one support member and the tilting rack at a center of gravity of the at least one rafter.

Various aspects of the present disclosure may be further characterized by one or more of the following clauses:

Clause 1: An arrangement for a photovoltaic module, the arrangement comprising at least one support member, and a tilting rack comprising at least one beam and at least one rafter, the at least one beam operatively connected to at least one end of the at least one rafter, wherein the tilting rack is operatively connected to the at least one support member at or near a center of gravity of the at least one rafter, and wherein the titling rack is configured to rotate at the center of gravity of the at least one rafter.

Clause 2: The arrangement of clause 1, wherein the tilting rack further comprises a bracket configured to connect the at least one beam to at least one end of the at least one rafter.

Clause 3: The arrangement of clause 1 or clause 2, further comprising a cantilever, the cantilever operatively connected to the tilting rack.

Clause 4: The arrangement of any of clauses 1 to 3, wherein the cantilever is operatively connected to the at least one support member.

Clause 5: The arrangement of any of clauses 1 to 4, wherein the tilting rack comprises at least one rail or at least one end rail for receiving the photovoltaic module, the at least one rail or the at least one end rail operatively connected to the at least one beam.

Clause 6: The arrangement of any of clauses 1 to 5, wherein the tilting rack comprises at least one rail and at least one end rail for receiving the photovoltaic module, the at least one rail and the at least one end rail operatively connected to the at least one beam.

Clause 7: The arrangement of any of clauses 1 to 6, wherein the at least one rail or the at least one end rail comprises one or more holes for aligning to the at least one beam.

Clause 8: The arrangement of any of clauses 1 to 7, wherein the at least one rail or the at least one end rail comprises two or more holes for aligning to the at least one beam.

Clause 9: The arrangement of any of clauses 1 to 8, wherein the at least one rail or the at least one end rail comprises three or more holes for aligning to the at least one beam.

Clause 10: The arrangement of any of clauses 1 to 9, wherein the at least one rail or the at least one end rail comprises four or more holes for aligning to the at least one beam.

Clause 11: The arrangement of any of clauses 1 to 10, wherein the at least one rail or the at least one end rail comprises five or more holes for aligning to the at least one beam.

Clause 12: The arrangement of any of clauses 1 to 11, wherein the at least one rail or the at least one end rail comprises six or more holes for aligning to the at least one beam.

Clause 13: The arrangement of any of clauses 1 to 12, further comprising at least one brace operatively connected to the at least one rail or the at least one end rail and the at least one beam.

Clause 14: The arrangement of any of clauses 1 to 13, further comprising at least one brace operatively connected to the at least one rail, the at least one end rail, and the at least one beam.

Clause 15: The arrangement of any of clauses 1 to 14, further comprising a plurality of photovoltaic modules, the at least one rail or the at least one end rail configured to hold the plurality of photovoltaic modules.

Clause 16: The arrangement of any of clauses 1 to 15, further comprising a plurality of photovoltaic modules, the at least one rail and the at least one end rail configured to hold the plurality of photovoltaic modules.

Clause 17: The arrangement of any of clauses 1 to 16, wherein the at least one support member is substantially W-shaped, C-shaped, or H-shaped.

Clause 18: The arrangement of any of clauses 1 to 17, wherein the at least one support member is substantially W-shaped.

Clause 19: The arrangement of any of clauses 1 to 18, wherein the at least one support member is substantially C-shaped.

Clause 20: The arrangement of any of clauses 1 to 19, wherein the at least one support member is substantially H-shaped.

Clause 21: The arrangement of any of clauses 1 to 20, wherein the arrangement comprises no more than two support members.

Clause 22: A method of installing an arrangement for a photovoltaic module, the method comprising the steps of providing at least one support member and a tilting rack, the tilting rack comprising at least one beam and at least one rafter, the at least one beam operatively connected to at least one end of the at least one rafter, and connecting the at least one support member and the tilting rack at a center of gravity of the at least one rafter.

Clause 23: The method of clause 22, further comprising rotating the tilting rack at the center of gravity of the at least one rafter to a use position.

Clause 24: The method of clause 22 or clause 23, further comprising a cantilever, the cantilever operatively connected to the tilting rack when the tilting rack is in a non-use position.

Clause 25: The method of any of clauses 22 to 24, wherein the cantilever is operatively connected to the at least one support member when the tilting rack is in a use position.

Clause 26: The method of any of clauses 22 to 25, wherein the tilting rack comprises at least one rail or at least one end rail for receiving the photovoltaic module, the at least one rail or the at least one end rail operatively connected to the at least one beam, and the at least one rail or the at least one end rail comprises one or more holes.

Clause 27: The method of any of clauses 22 to 26, wherein the tilting rack comprises at least one rail and at least one end rail for receiving the photovoltaic module, the at least one rail and the at least one end rail operatively connected to the at least one beam, and the at least one rail and the at least one end rail comprises one or more holes.

Clause 28: The method of any of clauses 22 to 27, wherein the tilting rack comprises at least one rail or at least one end rail for receiving the photovoltaic module, the at least one rail or the at least one end rail operatively connected to the at least one beam, and the at least one rail or the at least one end rail comprises two or more holes.

Clause 29: The method of any of clauses 22 to 28, wherein the tilting rack comprises at least one rail or at least one end rail for receiving the photovoltaic module, the at least one rail or the at least one end rail operatively connected to the at least one beam, and the at least one rail or the at least one end rail comprises three or more holes.

Clause 30: The method of any of clauses 22 to 29, wherein the tilting rack comprises at least one rail or at least one end rail for receiving the photovoltaic module, the at least one rail or the at least one end rail operatively connected to the at least one beam, and the at least one rail or the at least one end rail comprises four or more holes.

Clause 31: The method of any of clauses 22 to 30, wherein the tilting rack comprises at least one rail or at least one end rail for receiving the photovoltaic module, the at least one rail or the at least one end rail operatively connected to the at least one beam, and the at least one rail or the at least one end rail comprises five or more holes.

Clause 32: The method of any of clauses 22 to 31, wherein the tilting rack comprises at least one rail or at least one end rail for receiving the photovoltaic module, the at least one rail or the at least one end rail operatively connected to the at least one beam, and the at least one rail or the at least one end rail comprises six or more holes.

Clause 33: The method of any of clauses 22 to 32, further comprising aligning the at least one rail or the at least one end rail to the at least one beam.

Clause 34: The method of any of clauses 22 to 33, further comprising connecting a plurality of photovoltaic modules to the at least one rail or the at least one end rail.

Clause 35: The method of any of clauses 22 to 34, further comprising connecting a plurality of photovoltaic modules to the at least one rail and the at least one end rail.

### BRIEF DESCRIPTION OF THE DRAWINGS

The novel features described herein are set forth with particularity in the appended claims. Such features, however, both as to organization and methods of operation, may be better understood by reference to the following description, taken in conjunction with the accompanying drawings.

FIGS. 1A-1B are perspective views of a photovoltaic module arrangement according to one example of the present disclosure;

FIG. 1C is a perspective view of a rafter and a cantilever according to one example of the present disclosure;

FIG. 2A is a perspective view of the rafter including the cantilever and a bracket according to one example of the present disclosure;

FIG. 2B is a side view of the photovoltaic module arrangement according to one example of the present disclosure;

FIG. 2C is a perspective view of the photovoltaic module arrangement according to one example of the present disclosure;

FIG. 3A-3C are perspective views of a rail and an end rail according to some examples of the present disclosure;

FIG. 3D is a perspective view of a brace according to one example of the present disclosure;

FIGS. 4A-4C are perspective views of the support member and a connector channel according to some examples of the present disclosure;

FIG. 4D is a side view of the photovoltaic module arrangement according to an additional example of the present disclosure; and

FIGS. 5A-5B are side views of the photovoltaic module arrangement including a coupling nut according to some examples of the present disclosure.

### DESCRIPTION OF THE DISCLOSURE

In the following detailed description, reference is made to the accompanying drawings, which form a part hereof. The illustrative features shown and described in the detailed description, drawings, and claims are not meant to be limiting. Other features may be utilized, and other changes may be made, without departing from the scope of the subject matter presented here.

Before describing the various aspects of the photovoltaic module arrangement and various features thereof in detail, it should be noted that the various aspects disclosed herein are not limited in their application or use to the details of construction and arrangement of parts illustrated in the accompanying drawings and description. Rather, the disclosed devices may be positioned or incorporated in other devices, variations, and modifications thereof, and may be practiced or carried out in various ways. Accordingly, aspects of the photovoltaic module arrangement disclosed herein are illustrative in nature and are not meant to limit the scope or application thereof. Furthermore, unless otherwise indicated, the terms and expressions employed herein have been chosen for the purpose of describing the various aspects of the photovoltaic module arrangement features for the convenience of the reader and are not to limit the scope thereof. In addition, it should be understood that any one or more of the components of the photovoltaic module arrangement features, expressions thereof, and/or examples thereof, can be combined with any one or more of the other components, expressions thereof, and/or examples thereof, without limitation.

For purposes of the description hereinafter, spatial orientation terms, as used, shall relate to the referenced aspect as it is oriented in the accompanying drawings, figures, or otherwise described in the following detailed description. However, it is to be understood that the aspects described hereinafter may assume many alternative variations and configurations. It is also to be understood that the specific components, devices, features, and operational sequences illustrated in the accompanying drawings, figures, or otherwise described herein are simply exemplary and should not be considered as limiting.

Also, in the following description, it is to be understood that terms such as front, back, inside, outside, top, bottom, and the like are words of convenience and are not to be construed as limiting terms. Terminology used herein is not meant to be limiting insofar as devices described herein, or portions thereof, may be attached or utilized in other orientations. The various aspects of the photovoltaic module arrangement features will be described in more detail with reference to the drawings.

“About” as used herein means±10% of the referenced value. In certain embodiments, “about” means±9%, or ±8%, or ±7%, or ±6%, or ±5%, or ±4%, or ±3%, or ±2% or ±1% of the referenced value.

The present disclosure allows a photovoltaic module arrangement to be built so that each photovoltaic module connection can be made at a comfortable working height resulting in increased worker efficiency and therefore at a more cost-effective construction. The present disclosure further allows for increased worker safety by eliminating the need for a worker to use ladders and/or raise photovoltaic modules overhead. The present disclosure also allows for adaption to undulating terrain since each photovoltaic module arrangement is structurally independent from the adjacent arrangements. As currently designed, the present arrangement system can be installed, for example, on East-West slopes up to 21% slope (12°) and even steeper North and South Slopes. More importantly, the change in slope from one arrangement to an adjacent arrangement can be doubled at 24°. This present configuration also allows the photovoltaic module arrangement to be easily adjusted to different tilt angles, for example, to optimize the angle on a seasonal basis.

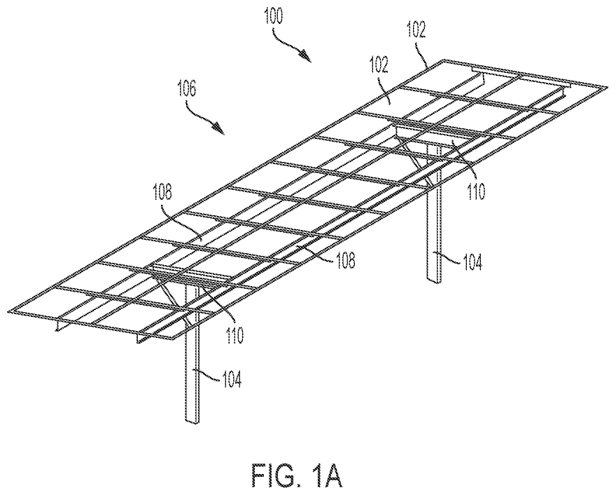

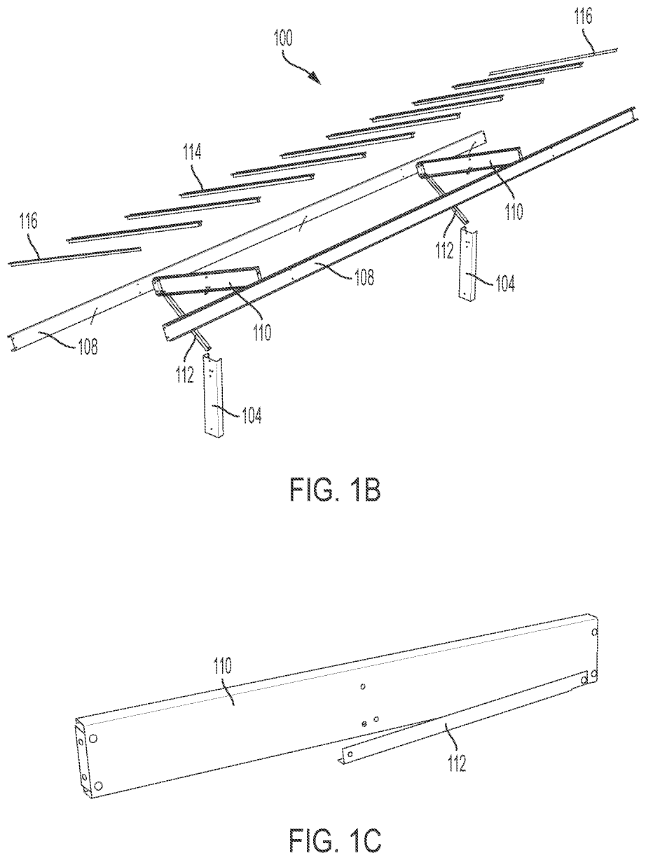

As shown in FIGS. 1A-1C, the present photovoltaic module arrangement (100) for a photovoltaic module (102) may include, in one non-limiting example of the present disclosure, at least one support member (104). In some embodiments, as illustrated in FIGS. 1A-1B, the photovoltaic module arrangement (100) may include two support members (104). In some non-limiting embodiments, the photovoltaic module arrangement (100) may include no more than two support members (104). It is to be understood that the support member (104) can be configured in one or more geometries, including, but not limited to a H-shape geometry, a C-shaped geometry, a W-shaped geometry, a round-shaped geometry, a square-shaped geometry, or a rectangular-shaped geometry.

Further in reference to FIGS. 1A-1C, the photovoltaic module arrangement (100) disclosed herein may include at least one support member (104) and a tilting rack (106). In some embodiments, the tilting rack (106) may comprise at least one beam (108) and at least one rafter (110). In further embodiments, as depicted in FIGS. 1A-1B, the tilting rack (106) may include two beams (108) and two rafters (110). In some embodiments, the tilting rack (106) can be operatively connected to the at least one support member (104) at or near a center of gravity of the at least one rafter (110). It is to be understood that connecting the at least one support member (104) at the center of gravity of the at least one rafter (110) allows an installer to rotate the titling rack (106) in a position that is favorable to the installers performing the assembly of the photovoltaic modules (102) on the tilting rack (106). In some embodiments, the tilting rack (106) can be operatively connected to two support members (104) at a center of gravity of two rafters (110) such that each of the two support members (104) is operatively connected to a center of gravity of each of the two rafters (110), as illustrated in FIG. 1A.

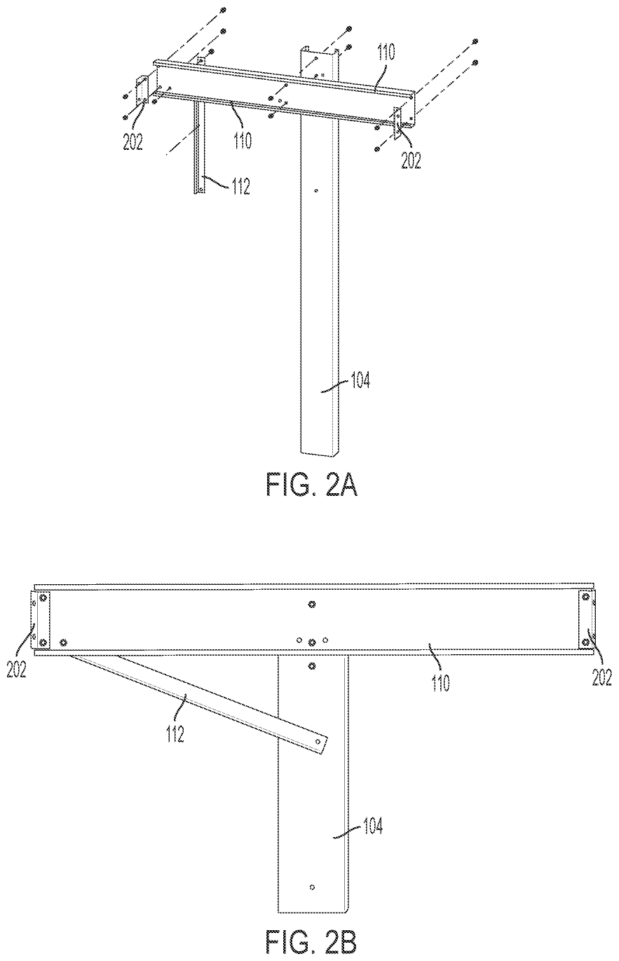

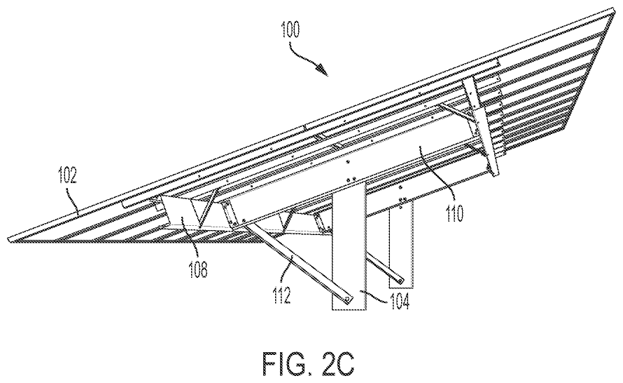

In some non-limiting embodiments of the present disclosure, the tilting rack (106) may further include one or more bracket (202), as illustrated in FIGS. 2A-2B. The one or more brackets (202) can be operatively connected to one or more ends of the rafter (110), as depicted in FIG. 2A. In some embodiments, the bracket (202) is configured to connect at least one beam (108) to at least one end of the rafter (110). In some embodiments, each end of the rafters (110) is operatively connected to a respective bracket (202), such that each bracket (202) is configured to connect to one beam (108) at each end of the rafter (110). It is to be understood that each end of rafter (110) may include a bracket (202) on each side of each end of rafter (110) such that each side can connect to beam (108), as illustrated in FIG. 1A.

Further in reference to FIGS. 1B-1C and FIGS. 2A-2C, the titling rack (106) may also include a cantilever (112). In some embodiments, as illustrated in FIG. 1B, the cantilever (112) can be operatively connected preferably, to the tilting rack (106), or more preferably to one end of the rafter (110). In some non-limiting embodiments, the cantilever (112) can be pre-assembled to one end of the rafter (110). As further described below, the cantilever (112) may allow for the tilting rack (106) to have a pre-use configuration and a use configuration. Referencing FIG. 2A, in the pre-use configuration, the cantilever (112) is operatively connected to the tilting rack (106) at one end of rafter (110). This pre-use configuration allows for the rotation of the titling rack (106) about a center of gravity of the rafter (110), as described above, to a position, or more than one position, that is favorable to the installers performing the assembly of the photovoltaic modules (102). Once the tilting rack (106) is in a favorable position for installing the photovoltaic modules (102), cantilever (112) can be further operatively connected to the support member (104), as illustrated in FIGS. 2B-2C, allowing for tilting rack (106) to have a use-configuration.

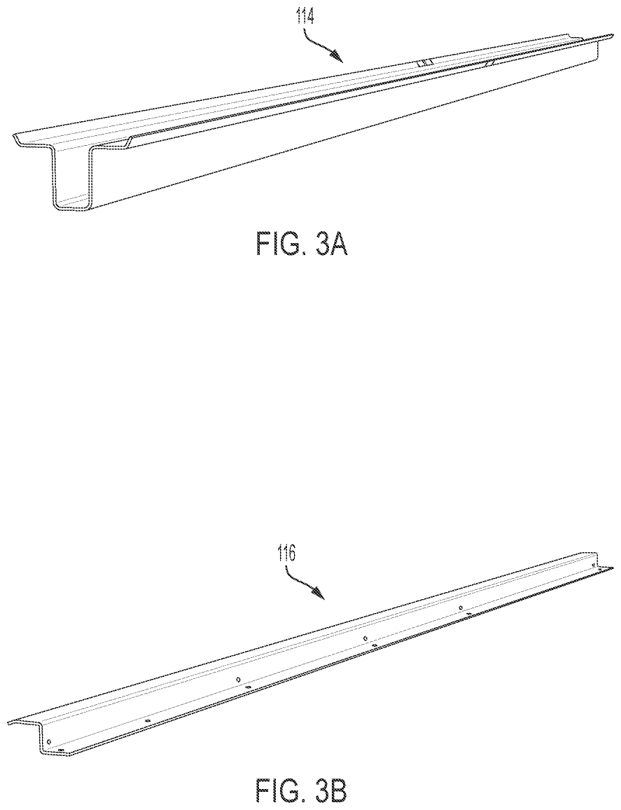

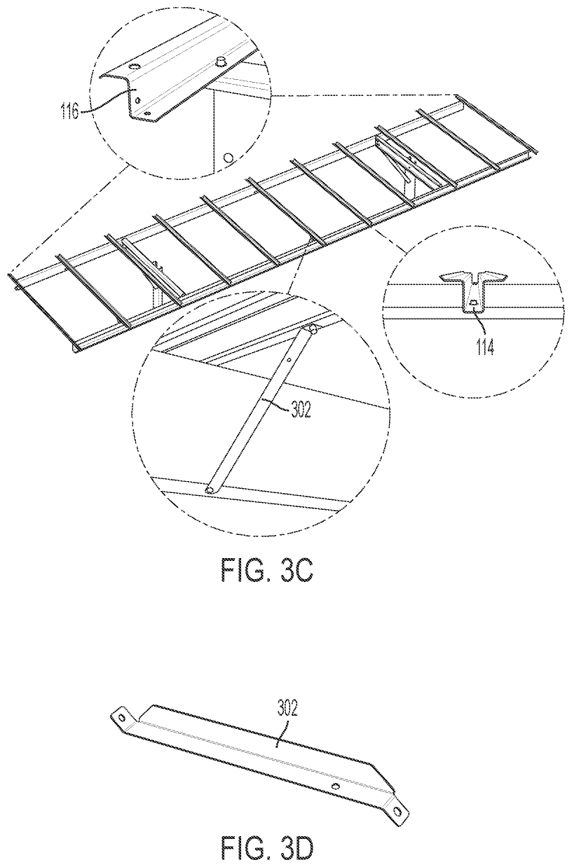

Referencing FIG. 1B and FIGS. 3A-3D, in some non-limiting embodiments of the present disclosure, the tilting rack (106) may further include at least one rail (114) or at least one end rail (116). In some embodiments, the tiling rack (106) may include a plurality of rails (114) and two end rails (116). In some embodiments, the at least one rail (114) or the at least one end rail (116) can be operatively connected to the at least one beam (108).

In some embodiments, the rail (114) can be configured in an upside-down hat orientation, as illustrated in FIG. 3A. The rail (114) can include an upper edge that defines an angle such that each end of rail (114) is configured to receive or align the photovoltaic module (102). As depicted in FIG. 3A, one or more ends of the upper edge of rail (114) can be configured in a turned-up configuration for receiving or aligning the photovoltaic module (102). As illustrated in FIG. 3A, the upper edge of rail (114) may also include one or more notches for receiving or aligning the photovoltaic module (102). It is contemplated herein that the one or more notches of rail (114) can be located at or near a center of rail (114) to act as stops for the photovoltaic module (102) thus holding the photovoltaic module (102) in place as the tilting rack (106) is tilted back and forth to fasten the photovoltaic module (102). In some embodiments, the one or more notches of rail (114) can be located at or near a distal end of a proximal end of rail (114).

Referencing FIGS. 3C-3D, in further embodiments of the present disclosure, the upper edge of rail (114) may include one or more holes for aligning or connecting the rail (114) to the photovoltaic module (102). In some embodiments, the one or more holes of the upper edge of rail (114) can be located at a proximal end, a distal end, or a center of the upper edge of rail (114). In some embodiments, as illustrated in FIGS. 3C-3D, a brace (302) is provided to allow for support of the rail (114) connection to beam (108).

Further in reference to the rail (114) illustrated in FIGS. 3A and 3C, a bottom portion of rail (114) may include one or more holes that can be used for aligning or connecting the rail (114) to the beam (108). In some embodiments, the one or more holes of the bottom portion of rail (114) can be located at a proximal end, a distal end, or a center of the bottom portion.

In some embodiments, the end rail (116) is configured as one half of rail (114) and may include one or more holes in the upper edge of end rail (116) or the bottom portion of end rail (116) for aligning end rail (116) to beam (108) as described above.

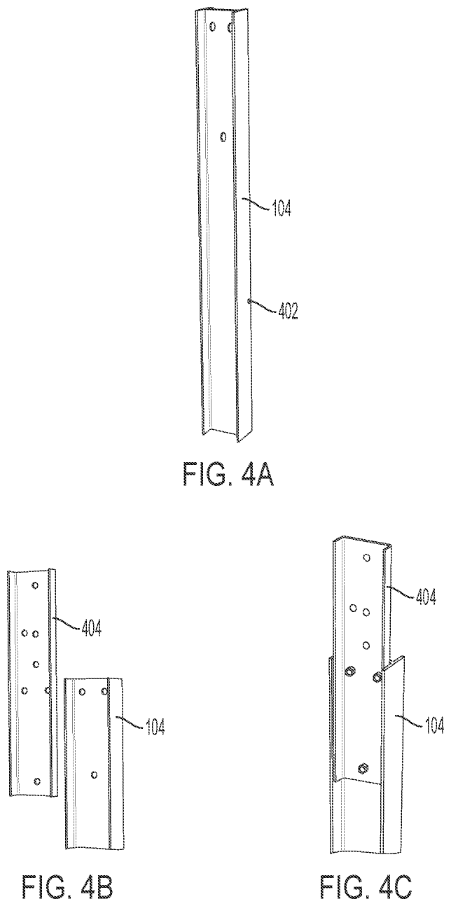

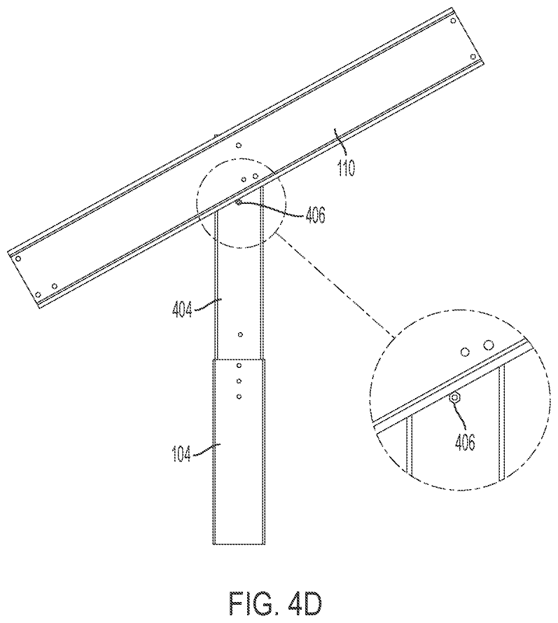

In some non-limiting aspects or embodiments of the present disclosure, the support member (104) may further include a hole (402) on one or more sides of the support member (104), as illustrated in FIG. 4A. In some embodiments, the hole (402) of the support member (104) is located on a south-facing flange of the support member (104). In some embodiments, the hole (402) is configured to receive or couple the cantilever (112). In some embodiments, the hole (402) is configured to receive or couple the cantilever (112) when the tilting rack (106) is in a use position.

In further embodiments of the present disclosure, a connector channel (404) is provided, as illustrated in FIG. 4B. In some embodiments, the connector channel (404) is configured to attach to the support member (104) to provide additional support to the beam or tilting rack (106), as depicted in FIGS. 4C-4D.

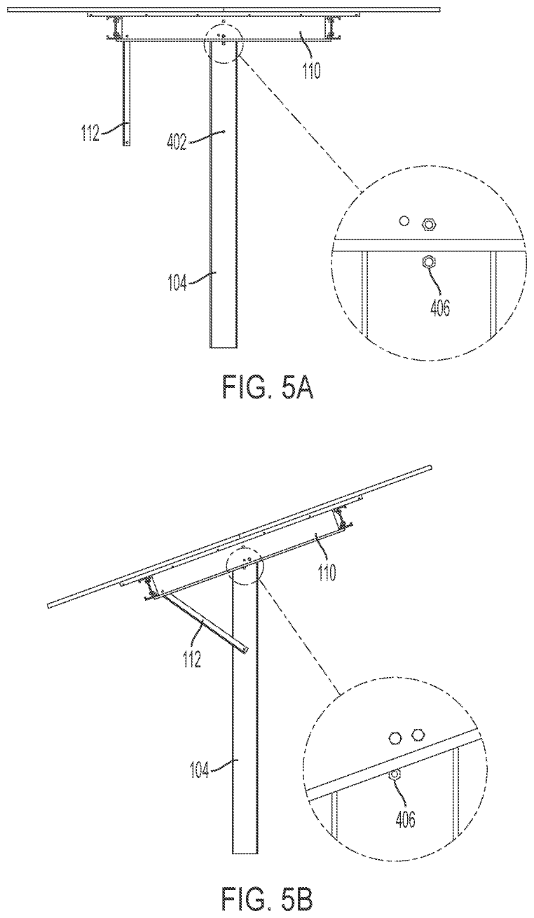

In additional non-limiting aspects or embodiments, a coupling nut (406) is provided. In some embodiments, the coupling nut (406) can be connected to the connector channel (404), as illustrated in FIG. 4D, or the coupling nut (406) can be connected to the support member (104), as illustrated in FIGS. 5A-5B. It is to be understood that the coupling nut (406) acts as a stop from over-tilting tilting rack (106) when the tilting rack (106) is either in the pre-use (FIG. 5A) or use position (FIG. 5B).

The present disclosure further relates to a method of installing a photovoltaic module arrangement (100). In some embodiments, the method of installing the photovoltaic module arrangement (100) includes providing at least one support member (104), preferably two support members (104), and a tilting rack (106). In some embodiments, the tilting rack (106) may include at least one beam (108), preferably two beams (108), operatively connected to at least one end of at least one rafter (110), preferably two rafters (110). The method of installing the photovoltaic module arrangement (100) may further include connecting the at least one support member (104) to the tilting rack (106) at a center of gravity of the at least one rafter (110). In some embodiments, the method of installing further includes a cantilever (112) operatively connected to the tilting rack (106), or more preferably operatively connected to the rafter (110), when the tilting rack (106) is in a non-use position. In some embodiments, the method of installing further includes rotating the tilting rack (106) about a center of gravity of the rafter (110). The method of installing may further include herein providing at least one rail (114) or at least one end rail (116) operatively connected to the beam (108). In some embodiments, the method of installing further includes rotating the tilting rack (106) about a center of gravity of the rafter (110) to install a plurality of photovoltaic modules (102) onto the at least one rail (114) or the at least one end rail (116) when the tilting rack (106) is in the pre-use position. In some embodiments, the method of installing includes rotating the tilting rack (106) about a center of gravity of the rafter (110) to a use position and connecting the cantilever (112) to the support member (104).

While aspects of a tilting arrangement are shown in the accompanying figures and described hereinabove in detail, other aspects will be apparent to, and readily made by, those skilled in the art without departing from the scope and spirit of the invention. Accordingly, the foregoing description is intended to be illustrative rather than restrictive. The invention described hereinabove is defined by the appended claims and all changes to the invention that fall within the meaning and the range of equivalency of the claims are to be embraced within their scope.

It is worthy to note that any reference to “one embodiment” or “an embodiment” means that a particular feature, structure, or characteristic described in connection with the embodiment is included in at least one embodiment. Thus, appearances of the phrases “in one embodiment” or “in an embodiment” in various places throughout the specification are not necessarily all referring to the same embodiment. Furthermore, the particular features, structures, or characteristics may be combined in any suitable manner in one or more embodiments.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

With respect to the use of any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other different components. It is to be understood that such depicted architectures are merely exemplary, and that, in fact, many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include, but are not limited to, physically mateable and/or physically interacting components, and/or wirelessly interactable, and/or wirelessly interacting components, and/or logically interacting, and/or logically interactable components.

Some aspects may be described using the expression “coupled” and “connected” along with their derivatives. It should be understood that these terms are not intended as synonyms for each other. For example, some aspects may be described using the term “connected” to indicate that two or more elements are in direct physical or electrical contact with each other. In another example, some aspects may be described using the term “coupled” to indicate that two or more elements are in direct physical or electrical contact. The term “coupled,” however, also may mean that two or more elements are not in direct contact with each other, but yet still co-operate or interact with each other.

In some instances, one or more components may be referred to herein as “configured to,” “operative,” “adapted,” etc. Those skilled in the art will recognize that “configured to” can generally encompass active-state components, and/or inactive-state components, and/or standby-state components, unless context requires otherwise.

While particular aspects of the subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

In summary, numerous benefits have been described which result from employing the concepts described herein. The foregoing disclosure has been presented for purposes of illustration and description. It is not intended to be exhaustive or limiting to the precise form disclosed. Modifications or variations are possible in light of the above teachings. It is intended that the claims submitted herewith define the overall scope of the present disclosure.

The invention claimed is:

1. An arrangement for a photovoltaic module, the arrangement comprising:
at least one support member; and
a tilting rack comprising at least one beam and at least one rafter, the at least one beam operatively connected to at least one end of the at least one rafter,
wherein the tilting rack is operatively connected to the at least one support member at or near a center of gravity of the at least one rafter, and
wherein the titling rack is configured to rotate at the center of gravity of the at least one rafter.

2. The arrangement of claim 1, wherein the tilting rack further comprises a bracket configured to connect the at least one beam to at least one end of the at least one rafter.

3. The arrangement of claim 1, further comprising a cantilever, the cantilever operatively connected to the tilting rack.

4. The arrangement of claim 3, wherein the cantilever is operatively connected to the at least one support member.

5. The arrangement of claim 1, wherein the tilting rack comprises at least one rail or at least one end rail for receiving the photovoltaic module, the at least one rail or the at least one end rail operatively connected to the at least one beam.

6. The arrangement of claim 5, wherein the at least one rail or the at least one end rail comprises one or more holes for aligning to the at least one beam.

7. The arrangement of claim 6, further comprising at least one brace operatively connected to the at least one rail or the at least one end rail and the at least one beam.

8. The arrangement of claim 6, further comprising a plurality of photovoltaic modules, the at least one rail or the at least one end rail configured to hold the plurality of photovoltaic modules.

9. The arrangement of claim 1, wherein the at least one support member is substantially W-shaped, C-shaped, H-shaped, round-shaped, square-shaped, or rectangular-shaped.

10. The arrangement of claim 1, wherein the arrangement comprises no more than two support members.

11. A method of installing an arrangement for a photovoltaic module, the method comprising the steps of:
providing at least one support member and a tilting rack, the tilting rack comprising at least one beam and at least one rafter, the at least one beam operatively connected to at least one end of the at least one rafter; and
connecting the at least one support member and the tilting rack at a center of gravity of the at least one rafter.

12. The method of claim 11, further comprising rotating the tilting rack at the center of gravity of the at least one rafter to a use position.

13. The method of claim 11, further comprising a cantilever, the cantilever operatively connected to the tilting rack when the tilting rack is in a non-use position.

14. The method of claim 13, wherein the cantilever is operatively connected to the at least one support member when the tilting rack is in a use position.

15. The method of claim 11, wherein the tilting rack comprises at least one rail or at least one end rail for receiving the photovoltaic module, the at least one rail or the at least one end rail operatively connected to the at least one beam, and the at least one rail or the at least one end rail comprises one or more holes.

16. The method of claim 15, further comprising aligning the at least one rail or the at least one end rail to the at least one beam.

17. The method of claim 15, further comprising connecting a plurality of photovoltaic modules to the at least one rail or the at least one end rail.
